(19) United States
(12) Patent Application Publication
(10) Pub. No.: US 2006/0118752 A1
(43) Pub. Date: Jun. 8, 2006

(54) Loading structure for a valve

(76) Inventors: Lin Tin-Kai, Taichung City (TW); Chiang Wen-Chin, Taichung City (TW); Wang Tzu-Chun, Tanzih Township (TW)

Correspondence Address: PRO-TECTOR INTERNATIONAL SERVICES, 20775 NORADA CT., SARATOGA, CA, 95070, US

(21) Appl. No.: 11/290,246

(22) Filed: Nov. 29, 2005

(30) Foreign Application Priority Data
Dec. 7, 2004 (TW) 094205149

(51) Int. Cl. F16K 1/00; F16K 15/00

(52) U.S. Cl. 251/331

(57) ABSTRACT

A loading structure for a valve comprises: an anti-leak pad defined onto a valve body, a metal diaphragm and a compression member both above the anti-leak pad, a loading unit having an outwardly extended loading seat, a resilient element and a driving element which is above the diaphragm, a central shaft for driving said loading unit, wherein the resilient element is located at said loading seat, the loading seat for downward or upward moving and compressing the driving element of loading unit is arranged below the resilient element, whereby when the loading unit excessively urges the diaphragm to matingly engage with the anti-leak pad, enabling the counterforce of anti-leak pad to urge the driving element of loading unit to upwardly compress the resilient element in such a manner that the shock-absorbing and anti-elastic fatigue functions can be improved, thus providing a prolonged service life for the loading structure of valve.

### BACKGROUND OF THE INVENTION

1. Field of the Invention

The present invention relates to a loading structure for a valve which can improve the shock-absorbing and anti-elastic fatigue functions, thus providing a prolonged service life for the loading structure of valve.

2. Description of the Prior Arts

At present, valves for controlling the flowing fluid in the pipes are commonly applied in the opto-electronic technology, pharmaceutics technology or biotech industry and the like. Because some flowing fluids in the pipes are poisonous and corrosive, an anti-leak function is very important for valves. Referring to FIG. 1, a conventional valve comprises an inflow route 2 and an outflow route 3 respectively arranged at the two sides of valve body 1, an inwardly concaved support cavity 4 in communication with the inflow route 2 and the outflow route 3 formed on the top surface of valve body 1, an annular recess 5 for retaining an anti-leak pad 6 arranged at the bottom surface of support cavity 4, an outwardly extended holder 7 for locating a metal diaphragm 8 arranged proximally to the wall of support cavity 4, a compression member 9 abutting against the periphery of diaphragm 8, a loading member 10 above the diaphragm 8, a central shaft 11 for driving the loading member 10, a shaft seat 12 for screwing the central shaft 11 therein engaged with the compression member 9, wherein one upwardly projected end of shaft seat 12 is used to be driven, and a positioning screw bush 13 is applied to combine the shaft seat 12 and the valve body 1 together, whereby when the valve is in the turn-on status, the diaphragm 8 will keep a proper space with the anti-leak pad 6 thank to the central shaft 11 and the loading member 10 don't compress the diaphragm 8, said proper space forms between the diaphragm 8 and the anti-leak pad 6 can provide the fluid in the inflow route 2 to flow into the outflow route 3. Referring to FIG. 2, when the valve is in the turn-off status, the central shaft 11 will be driven to urge the loading member 10 downwardly abut against the diaphragm 8, so as to the diaphragm 8 can matingly engage with the anti-leak pad 6 in such a manner that the inflow route 2 can be closed without any leak of fluid. In other words, by using a light pressure occurs between the diaphragm 8 and the anti-leak pad 6, the molecule of fluid can be stopped flowing through the diaphragm 8 as well as the anti-leak pad 6. Referring to FIG. 3, if the user exerts an excessive force, the central shaft 11 will urge the loading member 10 to cause a greatly downward movement, in this situation, not only the inflow route 2 can't be closed well, but also the diaphragm 8 can overly engage with the anti-leak pad 6. Consequently, the elasticity of anti-leak pad 6 is susceptible to fatigue due to the repeated usage; what is worse, when the diaphragm 8 is urged to a predetermined position in next use, it probably can't engage with the anti-leak pad 6; accordingly, a poor anti-leak function will occur due to an excessive force exertion. Moreover, in the manufacturing processes, the anti-leak pad 6 is merely inserted into but not being retained in the recess 5 of valve body 1, and then by using a peripheral projection of recess 5, said anti-leak pad 6 can therefore be retained in the recess 5. Hence, if said peripheral projection of recess 5 can not be used to efficiently retain the anti-leak pad 6, said anti-leak pad 6 will disengage from the recess 5 easily.

The present invention has arisen to mitigate and/or obviate the afore-described disadvantages.

### SUMMARY OF THE INVENTION

The primary objective of the present invention is to provide a loading structure for a valve of which service life can be prolonged efficiently. Said loading structure for the valve provided in accordance with the present invention comprises an anti-leak pad defined onto a valve body, a metal diaphragm and a compression member both above the anti-leak pad, a loading unit having an outwardly extended loading seat, a resilient element and a driving element which is above the diaphragm, a central shaft for driving said loading unit, wherein the resilient element is located at said loading seat, the loading seat for downward or upward moving and compressing the driving element of loading unit is arranged below the resilient element, whereby enabling the central shaft to urge the loading unit to cause a greatly downward movement, when the user exerts an excessive force, in such a manner that the driving member of loading unit can be urged by the counterforce of anti-leak pad to upwardly compress the resilient member thank to it matingly engages with said anti-leak pad, so as to provide an shock-absorbing effect to prevent elasticity fatigue for the metal diaphragm and the anti-leak pad. Hence, the service life of the loading structure of valve can be prolonged.

The secondary objective of the present invention is to provide a loading structure for a valve that can improve an anti-leak function for the valve. An anti-leak improving means is to provide with a height difference among the two walls of a retaining groove of valve body and the anti-leak pad, when the diaphragm is urged by the loading unit to contact with said two walls of a retaining groove and the anti-leak pad respectively, a multi-seal isolation will therefore form, so as to enhance the anti-leak function. Another anti-leak improving means is to arrange an annular recess at the bottom surface of a compression member so that the two sides of annular recess will respectively form an anti-leak surface, by using the respective anti-leak surfaces, a multi-seal effect will occur; hence, the anti-leak function will be further enhanced.

Another objective of the present invention is to provide a loading structure for a valve that can easy assemble and retain the anti-leak pad to the valve body. To realize this objective, the retaining groove for locking a hook portion of anti-leak pad is defined at the bottom of a support cavity of valve body in such a manner that the anti-leak pad can be easy assembled and retained.

### BRIEF DESCRIPTION OF THE DRAWINGS

FIG. 1 shows a conventional valve in a turn-on status;

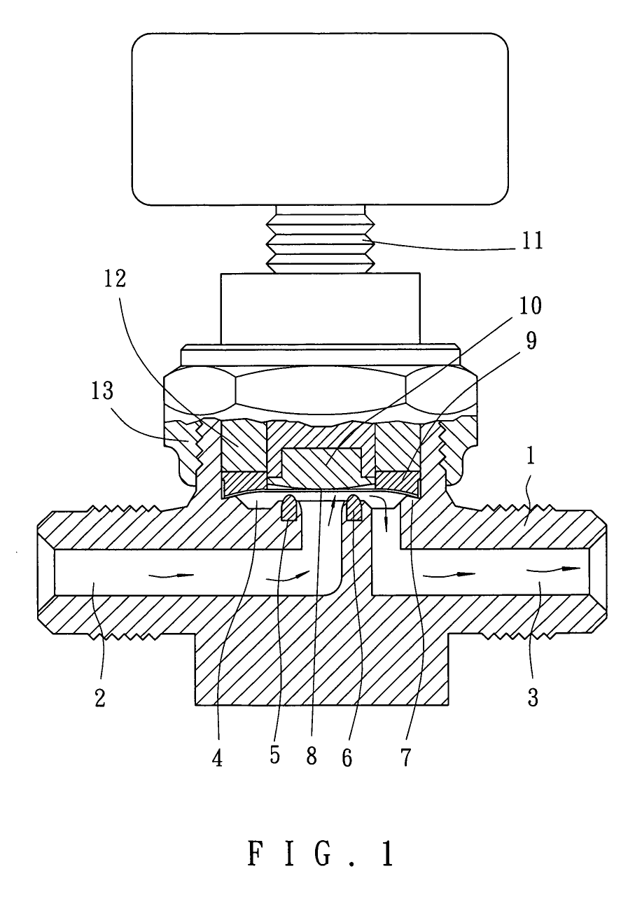

FIG. 2 shows the conventional valve in a turn-off status;

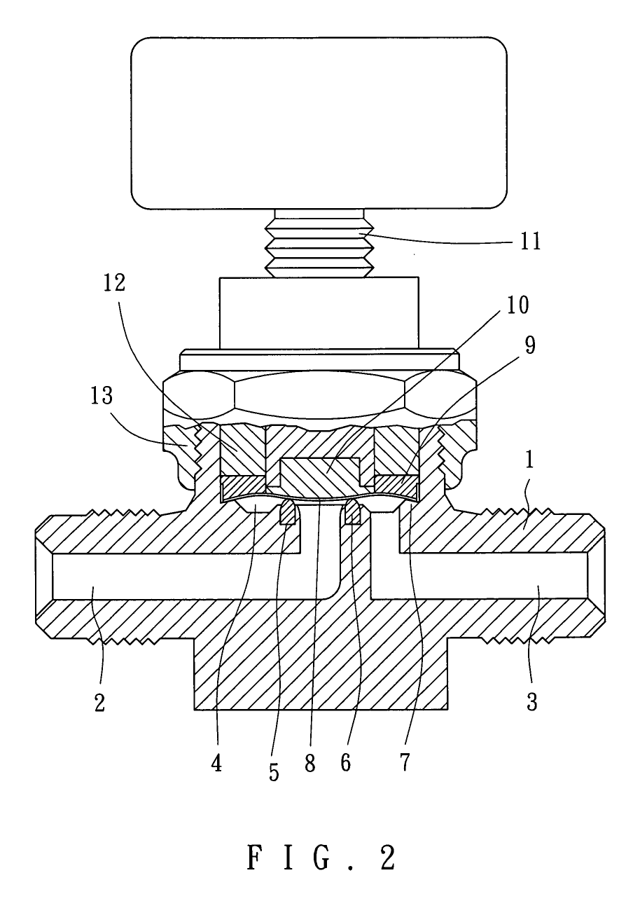

FIG. 3 shows a conventional loading member of valve excessively urging a diaphragm to matingly engage with an anti-leak pad;

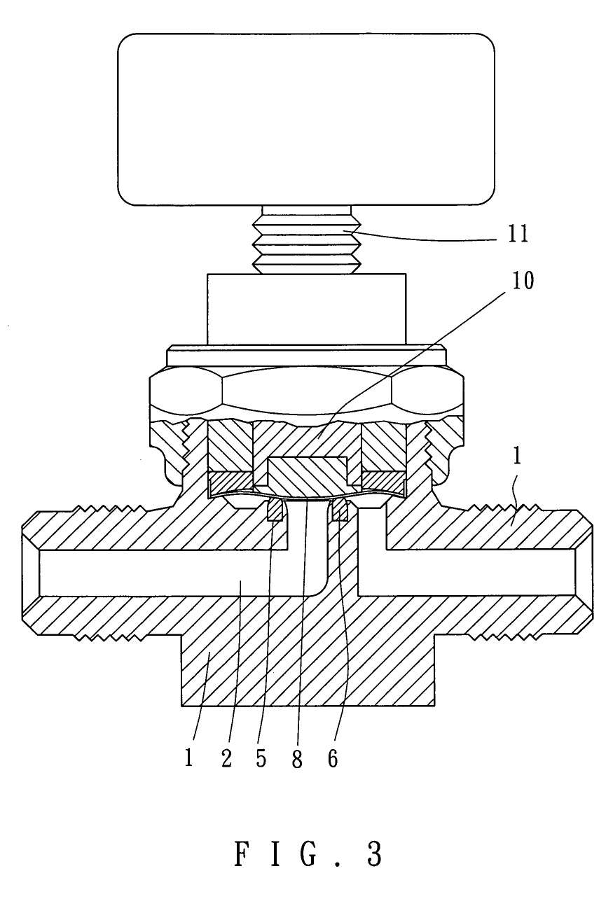

FIG. 4 is an exploded view of a loading structure for a valve in accordance with the present invention;

FIG. 5 is an assembly view of the loading structure for the valve in accordance with the present invention;

FIG. 6 is a partial amplification view of FIG. 5;

FIG. 7 shows the valve of present invention in a turn-off status;

FIG. 8 is a partial amplification view of FIG. 7;

FIG. 9 shows the valve of present invention in a turn-on status;

### DETAILED DESCRIPTION OF THE PREFERRED EMBODIMENTS

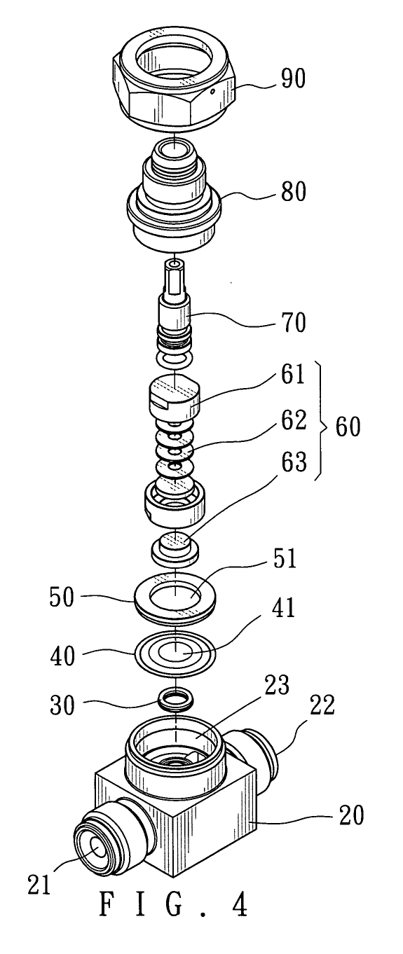

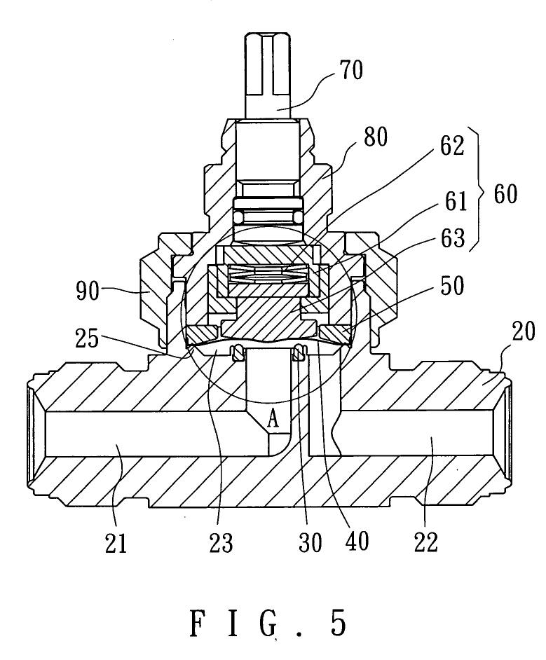

Referring to FIGS. 4-6, a loading structure for a valve provided in accordance with the present invention is shown and comprises an inflow route 21 and an outflow route 22 respectively disposed at two sides of a valve body 20, a support cavity 23 in communication with the inflow route 21 and the outflow route 22 formed on the top surface of valve body 20, a retaining groove 24 being mounted by the side of the entry of inflow route 21, and two walls 241-242 respectively formed on the two sides of retaining groove 24. Further, an outwardly extended holder 25 is disposed proximally to the wall of the bottom of support cavity 23, an anti-leak pad 30 having a hook portion 31 is inserted into the retaining groove 24 of valve body 24 by using said hook portion 31 in such a manner that said anti-leak pad 30 can be easy assembled and retained; also, a height different is arrange among the top surface of anti-leak pad 30 and the two walls of retaining groove 24. In addition, a metal diaphragm 40 provided with an intermediately concaved guide portion 41 is mounted on the holder 25 of valve body 20, a compression member 50 having a central hole 51 is defined with an annular recess 52 at the bottom surface thereof, and the annular recess 52 abuts against the outer periphery of diaphragm 40. A loading unit 60 is provided with a loading seat 61, wherein the loading seat 61 is formed of two respective covers, and a resilient member 62, such as a spring or a disc spring is located in the loading seat 61. At the bottom of resilient member 62 is disposed a driving member 63 capable of downward or upward moving and compressing the resilient member 62, and one end of driving member 63 projects out of the loading seat 61 to matingly engage with the diaphragm 40. A shaft seat 80 for screwing the central shaft 70 is arranged above the compression member 50, and one end of central shaft 70 abuts against the loading unit 60, while another end of it for being driven projects outwardly. By using a positioning screw bush 90, the shaft seat 80 and the valve body 20 can be assembled and retained together.

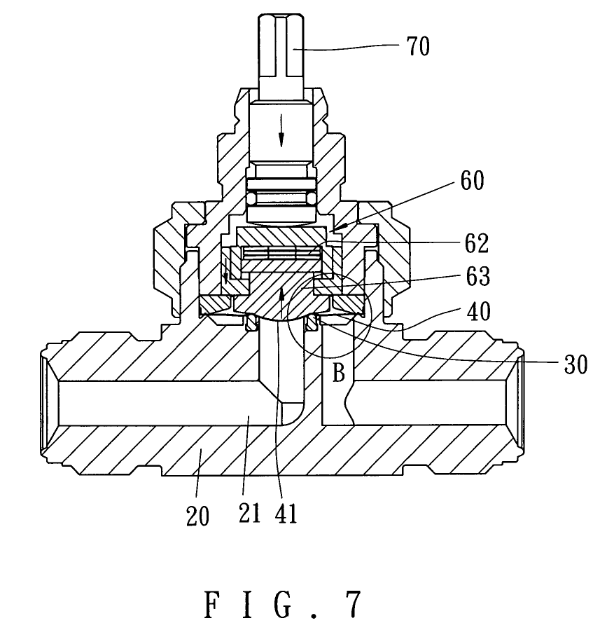

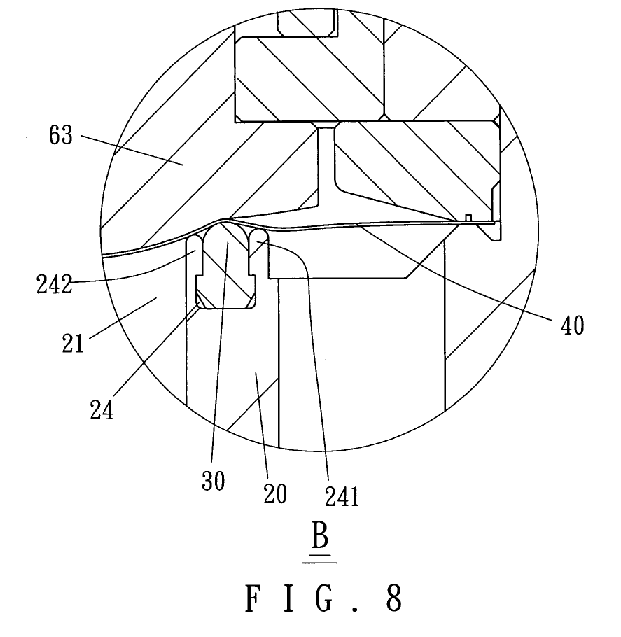

Referring to FIG. 7-8, when the user exerts an excessive force to close the valve, the central shaft 70 will urge the driving element 63 of loading unit 60, and when the diaphragm 40 matingly engages with the anti-leak pad 30 in view of the downward force, the counterforce of anti-leak pad 30 will urge the driving element 63 to upwardly move and compress the resilient element 62 in such a manner that not only the shock-absorbing effect but also the anti-failure function for the diaphragm 40 and the anti-leak pad 30 can be improved, thus enabling the inflow route 21 to be closed due to said diaphragm 40 matingly engages with the anti-leak pad 30. Further, among the two walls 241-242 of retaining groove 24 and the anti-leak pad 30 is designed to form a height difference, hence, when the diaphragm 40 contacts with said two walls 241-242 and the anti-leak pad 30 respectively, a multi-seal isolation will result in, so as to enhance the anti-leak effect of inflow route 21.

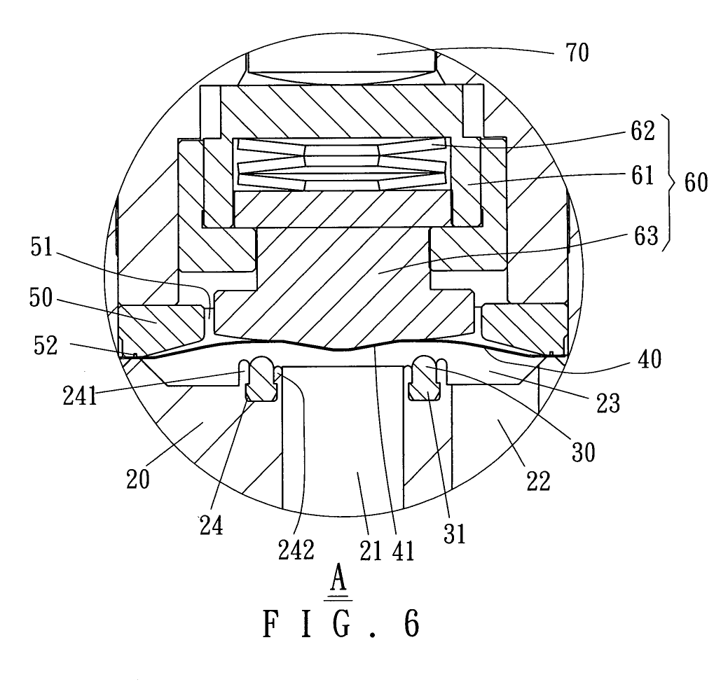

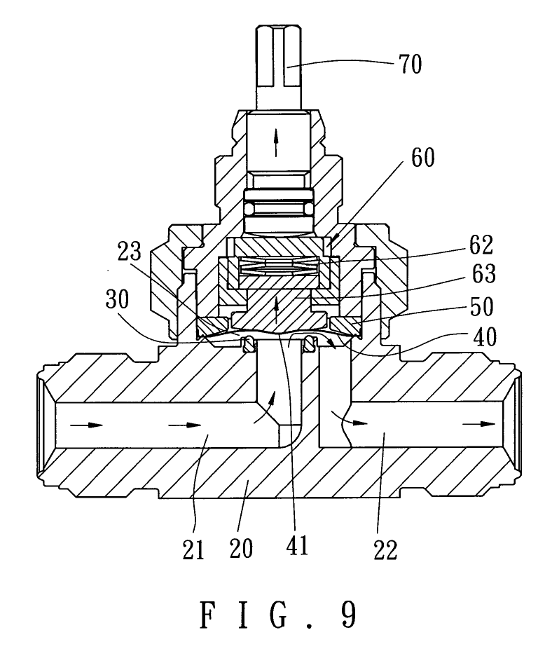

Referring to FIGS. 6 and 9, when the user turns on the valve, the central shaft 70 will urge the loading unit 60 to upwardly return and disengage from the diaphragm 40, and then said diaphragm 40 and the anti-leak pad 30 will therefore return to the predetermined height, thus enabling they matingly engage with each other in next use. Also, a proper space is provided between the diaphragm 40 and the anti-leak pad 30, so as to the fluid in the inflow route 21 of valve body 20 can flow into the support cavity 23. Further, by means of the guide portion 41 of diaphragm 40, said fluid will be guided to flow into the outflow route 22 more efficiently. In addition, an annular recess 52 is arranged at the bottom surface of compression member 52, as a result, the two sides of recess 52 will respectively form an anti-leak surface, by using the respective anti-leak surfaces, a multi-seal effect will occur; hence, the anti-leak function will be further enhanced.

While we have shown and described various embodiments in accordance with the present invention, it should be clear to those skilled in the art that further embodiments may be made without departing from the scope of the present invention.

What is claimed is:

1. A loading structure for a valve comprising:
an anti-leak pad defined onto a valve body, a diaphragm above the anti-leak pad, a compression member abutting against the periphery of diaphragm, a loading unit disposed above the diaphragm, wherein, a resilient element is disposed to the loading unit, a driving element is arranged below said resilient element, and one outwardly extended end of driving element matingly engages with the diaphragm 40, whereby enabling to prevent the elasticity fatigue of diaphragm due to being excessively urged, by using the shock-absorbing function of resilient element.

2. The loading structure for a valve as claimed in claim 1, wherein the diaphragm is made of metal.

3. The loading structure for a valve as claimed in claim 1, wherein the compression member is driven to move by a central shaft.

4. The loading structure for a valve as claimed in claim 1, wherein the resilient member is a spring or a disc spring.

5. The loading structure for a valve as claimed in claim 1, the resilient member is located in a loading seat of loading unit and one end thereof abuts against the driving element.

6. The loading structure for a valve as claimed in claim 1, wherein the top of compression member is screwedly retained by the shaft seat and a positioning screw bush, so as to further abuts against the periphery of diaphragm.

7. The loading structure for a valve as claimed in claim 1, wherein an annular recess is arranged at the bottom surface of compression member, so that the two sides of annular recess will respectively form an anti-leak surface as the compression member abuts against the periphery of diaphragm; by using the respective anti-leak surfaces, a multi-seal effect will therefore occur.

8. The loading structure for a valve as claimed in claim 1, wherein a retaining groove for locking a hook portion of anti-leak pad is defined in the valve body.

9. The loading structure for a valve as claimed in claim 1, wherein a height difference is provided among the two walls of a retaining groove of valve body and the anti-leak pad, accordingly, when the diaphragm contacts with said two walls of retaining groove and the anti-leak pad respectively, a multi-seal isolation will therefore form.
